(19) United States
(12) Patent Application Publication
(10) Pub. No.: US 2026/0180181 A1
(43) Pub. Date: Jun. 25, 2026

(54) ANTENNA APPARATUS AND ELECTRONIC DEVICE

(71) Applicant: VIVO MOBILE COMMUNICATION CO., LTD., Dongguan (CN)

(72) Inventor: Jifa BIAN, Dongguan (CN)

(73) Assignee: VIVO MOBILE COMMUNICATION CO., LTD., Dongguan (CN)

(21) Appl. No.: 19/537,506

(22) Filed: Feb. 12, 2026

Related U.S. Application Data
(63) Continuation of application No. PCT/CN2024/112980, filed on Aug. 19, 2024.

(30) Foreign Application Priority Data
Aug. 23, 2023 (CN) 202311073527.2

(51) Int. Cl. H01Q 7/00; H01Q 1/22; H01Q 1/52

(52) U.S. Cl. CPC H01Q 7/00; H01Q 1/22; H01Q 1/526

(57) ABSTRACT

An antenna apparatus and an electronic device are provided. The antenna apparatus includes: a substrate, a metal shielding cover disposed on the upper surface of the substrate, a metal ground plane disposed on the lower surface of the substrate, and at least one feeding structure. The metal shielding cover has an open side. The open side faces an edge of the substrate. A sidewall of the metal shielding cover is connected to the metal ground plane. The feeding structure includes: a first portion located outside the metal shielding cover, and a second portion located inside the metal shielding cover. The first portion and the second portion being connected to each other through the sidewall of the metal shielding cover. The feeding structure is configured to form a current loop inside a cavity of the metal shielding cover to excite a cavity antenna.

### CROSS-REFERENCE TO RELATED APPLICATIONS

The application is a continuation of International Application No. PCT/CN2024/112980, filed on Aug. 19, 2024, which claims priority to the Chinese Patent Application No. 202311073527.2, filed on Aug. 23, 2023. The entire contents of each of the above-referenced applications are expressly incorporated herein by reference.

### TECHNICAL FIELD

The present application pertains to the field of antennas and specifically relates to an antenna apparatus and an electronic device.

### BACKGROUND

With the development of information technology, mobile terminals have become an integral and essential part of people's lives, and the antenna design for mobile terminals is facing increasing challenges. In recent years, more and more tablet computers have adopted all-metal shells. However, electronic device with all-metal shells cannot use traditional frame antenna solutions. In the related art, cavity antennas composed of a substrate and a metal shielding cover are generally used. The feed line of the cavity antenna is routed along an edge of the substrate, together with antenna matching, and is soldered to a metal strip extending from the metal shielding cover to form a back-cavity slot antenna.

However, such an antenna has low reliability and is prone to desoldering at the feed solder joint due to drops, impacts, or other reasons, resulting in poor feed contact and degraded wireless transmission performance of the electronic device.

### SUMMARY

An objective of embodiments of the present application is to provide an antenna apparatus and an electronic device, so as to address the issue of low reliability of the cavity antenna in the related art.

In a first aspect, an embodiment of the present application provides an antenna apparatus, including a substrate, a metal shielding cover disposed on the upper surface of the substrate, a metal ground plane disposed on the lower surface of the substrate, and at least one feeding structure; where the metal shielding cover has an open side, the open side faces an edge of the substrate, and a sidewall of the metal shielding cover is connected to the metal ground plane; and the feeding structure includes a first portion located outside the metal shielding cover and a second portion located inside the metal shielding cover, the first portion and the second portion are connected to each other through the sidewall of the metal shielding cover; and the feeding structure may form a current loop inside a cavity of the metal shielding cover to excite a cavity antenna.

In a second aspect, an embodiment of the present application provides an electronic device including the antenna apparatus as described in the first aspect.

In the embodiments of the present application, the antenna apparatus includes a substrate, a metal shielding cover disposed on the upper surface of the substrate, a metal ground plane disposed on the lower surface of the substrate, and at least one feeding structure; where the metal shielding cover has an open side, the open side faces an edge of the substrate, and a sidewall of the metal shielding cover is connected to the metal ground plane; and the feeding structure includes a first portion located outside the metal shielding cover and a second portion located inside the metal shielding cover, the first portion and the second portion being connected to each other through the sidewall of the metal shielding cover; where the feeding structure is configured to form a current loop inside a cavity of the metal shielding cover to excite a cavity antenna. Through this solution, the cavity antenna can be excited by a current loop instead of soldering the feed line and the metal shielding cover together through a metal strip, thereby avoiding performance degradation of the antenna caused by loosening of the soldered portion and improving the reliability of the cavity antenna.

### BRIEF DESCRIPTION OF DRAWINGS

The drawings described herein are used to provide a further understanding of the present application and constitute a part of the present application. The exemplary embodiments of the present application and descriptions thereof are used to explain the present application and do not constitute an undue limitation to the present application.

FIG. 1a is a schematic structural diagram of an antenna apparatus in the related art;

FIG. 1b is a first structural cross-sectional view of an antenna apparatus in the related art;

FIG. 1c is a second structural cross-sectional view of an antenna apparatus in the related art;

FIG. 2a is a first schematic structural diagram of an antenna apparatus according to one embodiment of the present application;

FIG. 2b is a first structural cross-sectional view of an antenna apparatus according to one embodiment of the present application;

FIG. 2c is a second structural cross-sectional view of an antenna apparatus according to one embodiment of the present application;

FIG. 3a is a schematic diagram of a vertical feeding structure in an antenna apparatus according to one embodiment of the present application;

FIG. 3b is a schematic diagram of a horizontal feeding structure in an antenna apparatus according to one embodiment of the present application;

FIG. 3c is a simulation result diagram obtained by setting different lengths of a microstrip line in a vertical feeding structure according to one embodiment of the present application;

FIG. 3d is a simulation result diagram obtained by setting different lengths of a microstrip line in a horizontal feeding structure according to one embodiment of the present application;

FIG. 3e is a second schematic structural diagram of an antenna apparatus according to one embodiment of the present application according to one embodiment of the present application;

FIG. 3f is a simulation result diagram obtained by setting different lengths of a T-shaped microstrip line according to one embodiment of the present application;

FIG. 4a is a first schematic diagram of a first feeding structure in an antenna apparatus according to one embodiment of the present application;

FIG. 4b is a first schematic diagram of a second feeding structure in an antenna apparatus according to one embodiment of the present application;

FIG. 5a is a second schematic diagram of a first feeding structure in an antenna apparatus according to one embodiment of the present application;

FIG. 5b is a second schematic diagram of a second feeding structure in an antenna apparatus according to one embodiment of the present application;

FIG. 5c is a simulation result diagram obtained by setting different distances between a microstrip line and a metal shielding cover according to one embodiment of the present application;

FIG. 6 is a third schematic structural diagram of an antenna apparatus according to one embodiment of the present application;

FIG. 7a is a schematic diagram showing electric and magnetic field distributions when different modes are excited in an antenna apparatus according to one embodiment of the present application;

FIG. 7b is a schematic diagram showing a change in radiation patterns when different modes are excited in an antenna apparatus according to one embodiment of the present application.

### DETAILED DESCRIPTION

The technical solutions in the embodiments of the present application will be clearly described below in conjunction with the drawings in the embodiments of the present application. Obviously, the described embodiments are a part of the embodiments of the present application, rather than all the embodiments. Based on the embodiments in the present application, all other embodiments obtained by those of ordinary skill in the art without creative efforts shall fall within the protection scope of the present application.

The terms “first,” “second,” and the like in the description and claims of the present application are used to distinguish similar objects, but not to describe a specific order or sequence. It should be understood that the terms used in this way can be interchanged under appropriate circumstances so that the embodiments of the present application can be implemented in an order other than those illustrated or described herein. In addition, “and/or” in the description and claims means at least one of the connected objects, and the character “/” generally means that the associated objects before and after are in an “or” relationship.

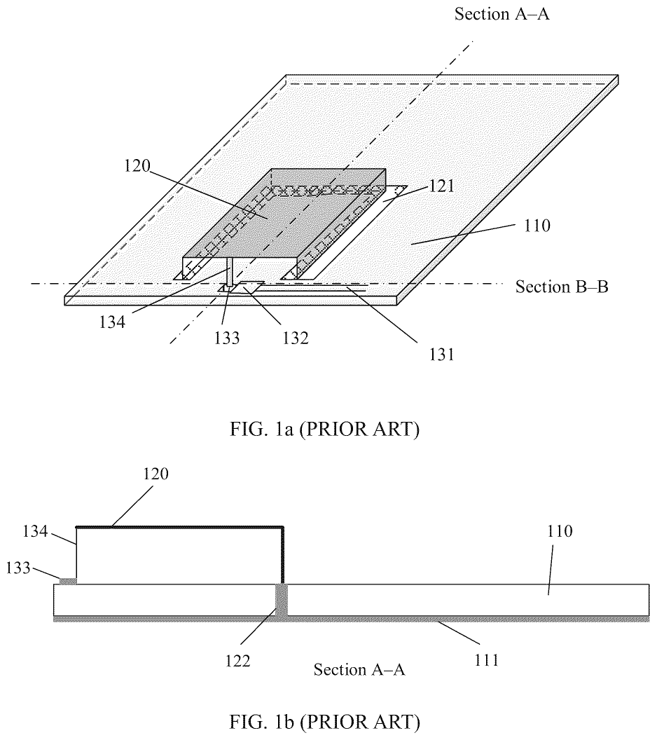

As shown in FIG. 1a to FIG. 1c, in the related art, a metal shielding cover 120 is provided on the upper surface of a substrate 110, and a metal ground plane 111 is provided on the lower surface of the substrate 110. The metal shielding cover 120 is soldered to a grounding metal 122 through a grounding solder joint 121, and the grounding metal 122 is connected to the metal ground plane 111, thereby grounding the metal shielding cover 120. A feed line 131 of the cavity antenna is routed along an edge of the substrate 110, together with antenna matching 132, and is soldered to a metal strip 134 extending from the metal shielding cover 120 through a feed solder joint 133, thereby forming a back-cavity slot antenna. This antenna is easily desoldered at the feed solder joint 133 due to drops, impacts, or other reasons, resulting in poor feed contact and degraded wireless transmission performance of the electronic device, and low reliability of the cavity antenna.

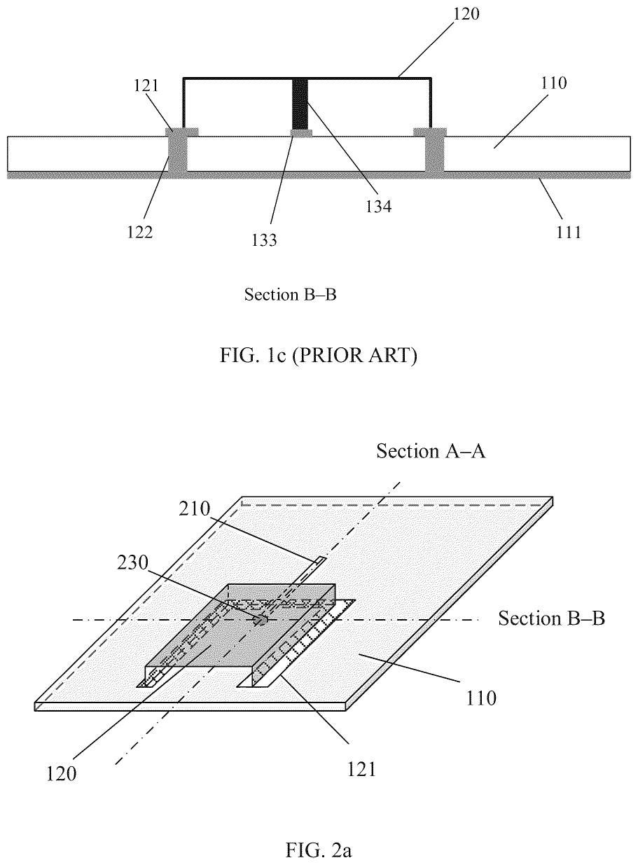

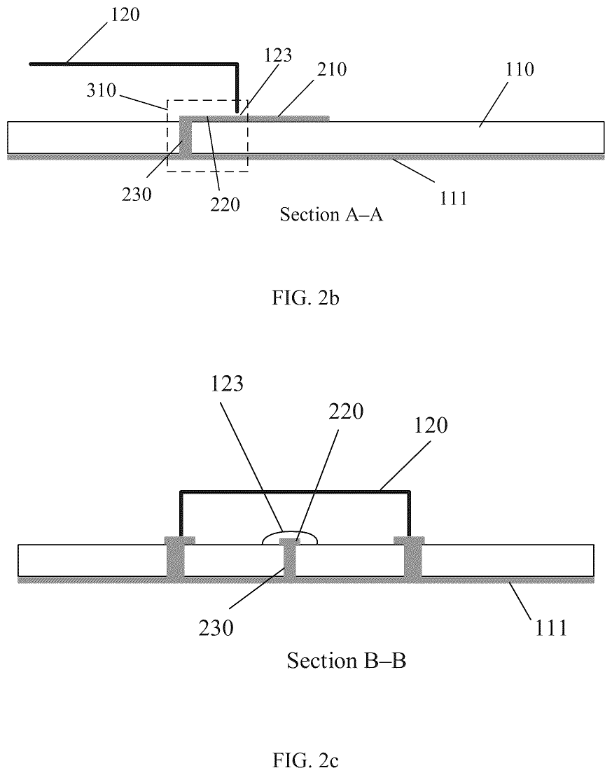

To address the issue of low reliability of the cavity antenna in the related art, the present application provides an antenna apparatus. FIG. 2a is a structural cross-sectional view of an antenna apparatus according to one embodiment of the present application, FIG. 2b is a structural cross-sectional view of section A of the antenna apparatus, and FIG. 2c is a structural cross-sectional view of section B of the antenna apparatus. The antenna apparatus includes a substrate 110, a metal shielding cover 120 disposed on the upper surface of the substrate 110, a metal ground plane 111 disposed on the lower surface of the substrate 110, and at least one feeding structure. The metal shielding cover 120 has an open side, the open side faces an edge of the substrate 110, and a sidewall of the metal shielding cover 120 is connected to the metal ground plane 111. The feeding structure includes a first portion located outside the metal shielding cover 120 and a second portion located inside the metal shielding cover 120, the first portion and the second portion are connected to each other through the sidewall of the metal shielding cover 120, and the feeding structure is configured to form a current loop 310 inside a cavity of the metal shielding cover 120 to excite a cavity antenna. For example, the first portion of the feeding structure is a feed line 210 located outside the metal shielding cover 120, and the second portion of the feeding structure includes a microstrip line 220 inside the metal shielding cover 120. Both the microstrip line 220 and the feed line 210 are distributed on the upper surface of the substrate 110. The microstrip line 220 extends from the feed line 210 into the interior of the metal shielding cover 120 through an avoidance hole 123 in the sidewall of the metal shielding cover 120, and then is connected to the metal ground plane 111 on the lower surface of the substrate 110 through via metal 230, thereby forming a current loop 310 to implement current-loop feeding.

In the antenna apparatus provided in the present application, the feeding structure passes through the sidewall of the metal shielding cover 120, the feeding structure is not disposed at the edge of the substrate 110 facing the open side of the metal shielding cover 120, but is disposed on a region near the sidewall of the metal shielding cover 120 and away from the edge of the substrate 110, and the antenna apparatus provided in the present application implements current-loop feeding by forming a current loop 310 inside the cavity of the metal shielding cover 120, rather than by soldering the feed line 210 and the metal shielding cover 120 together through a metal strip.

Thus, an embodiment of the present application provides an antenna apparatus, including a substrate 110, a metal shielding cover 120 disposed on the upper surface of the substrate 110, a metal ground plane 111 disposed on the lower surface of the substrate 110, and at least one feeding structure. The metal shielding cover 120 has an open side, the open side faces an edge of the substrate 110, and a sidewall of the metal shielding cover 120 is connected to the metal ground plane 111. The feeding structure includes a first portion located outside the metal shielding cover 120 and a second portion located inside the metal shielding cover 120, the first portion and the second portion being connected to each other through the sidewall of the metal shielding cover 120; where the feeding structure is configured to form a current loop 310 inside a cavity of the metal shielding cover 120 to excite a cavity antenna. Through this solution, the cavity antenna can be excited by a current loop 310 instead of soldering the feed line 210 and the metal shielding cover 120 together through a metal strip, thereby avoiding performance degradation of the antenna caused by loosening of the soldered portion and improving the reliability of the cavity antenna.

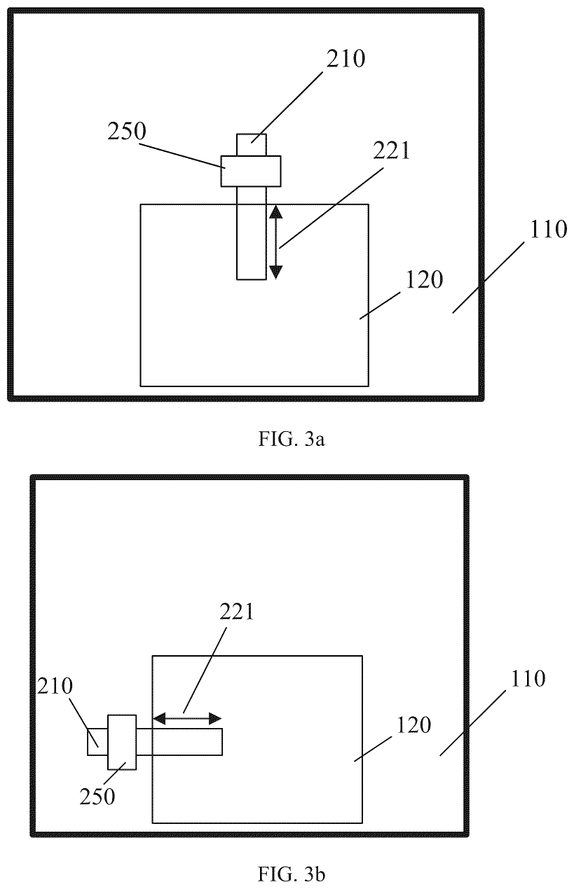

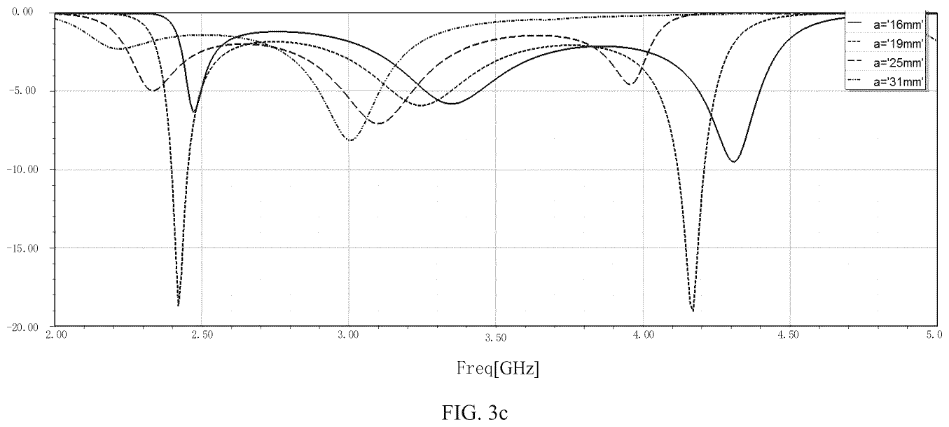

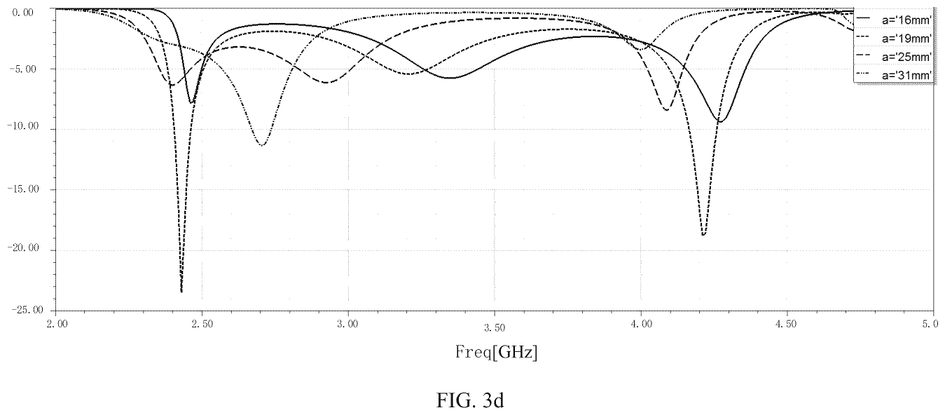

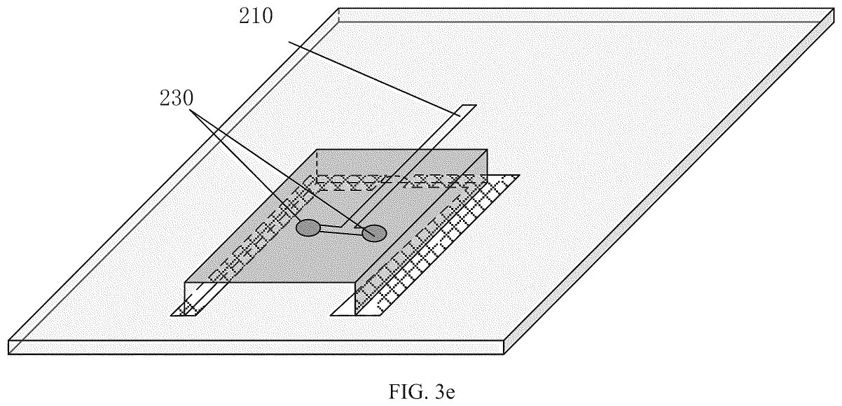

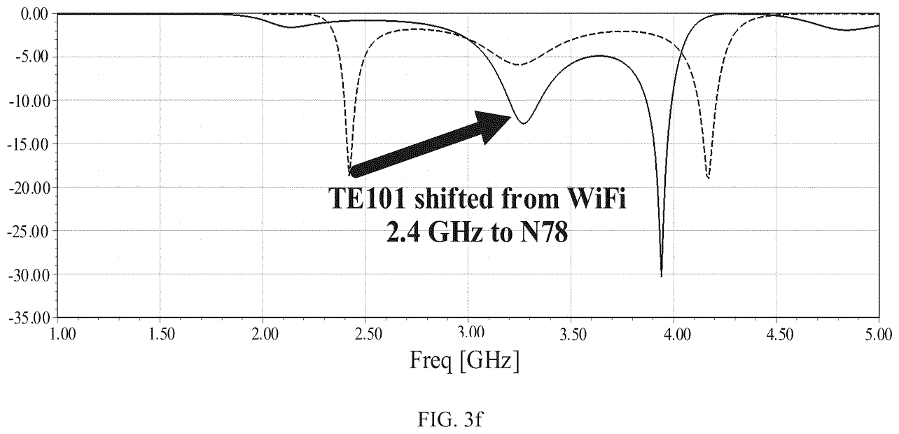

In one implementation, the feed position of the feeding structure can be set near any sidewall of the metal shielding cover 120. According to different feed positions, the feeding structure includes a vertical feeding structure and/or a horizontal feeding structure. A feeding direction of the vertical feeding structure coincides with an opening direction of the metal shielding cover 120, as shown in FIG. 3a; and a feeding direction of the horizontal feeding structure is orthogonal to the opening direction of the metal shielding cover 120, as shown in FIG. 3b. The feeding structure further includes a matching circuit 250.

The length 221 of the microstrip line 220 extending into the interior of the metal shielding cover 120 in the feeding structure is denoted as La. Different radiation effects can be achieved by setting different lengths of the microstrip line 220. FIG. 3c is a simulation result diagram obtained by setting different lengths of a microstrip line 220 in a vertical feeding structure, and FIG. 3d is a simulation result diagram obtained by setting different lengths of a microstrip line 220 in a horizontal feeding structure. In the simulation model, the cavity is an air cavity of 63 mm×63 mm×5 mm. It can be seen that lengthening the microstrip line 220 in the vertical feeding structure causes a significant shift in the resonance of the intermediate mode (around 3.3 GHZ) toward a lower frequency, but also affects the frequencies of the preceding and subsequent modes (TE101 and TE102), indicating that the vertical feeding structure is highly sensitive to the length of the microstrip line 220. Lengthening the microstrip line 220 in the horizontal feeding structure also causes a shift in the intermediate mode toward a lower frequency, but the resonance of the TE101 mode (around 2.4 GHZ) remains almost unchanged. Moreover, as the length of the microstrip line 220 increases, the two resonances can merge with each other, thereby broadening the bandwidth. This demonstrates that by setting an appropriate length of the microstrip line 220, new modes can be generated to increase the bandwidth of the antenna apparatus.

According to application requirements, an appropriate length of the microstrip line 220 is selected to control the frequency of the intermediate resonance. Combined with the adjustment of the matching circuit, this enables the implementation of a broadband antenna covering B40+WiFi 2.4+B41+N77/78 bands. If the height of the cavity is low, the Q value of the resonance becomes higher, and the mode remains unchanged, which is manifested as a narrower resonance bandwidth. In this case, an antenna switch can be loaded at the feed position. By switching between different paths of the switch to change a partial matching of the antenna, the radiation frequency can be altered, thereby covering the B40+WiFi 2.4+B41+N77/78 bands.

The length of the microstrip line 220 can be lengthened in the extending direction of the microstrip line 220, or formed as a zigzag line or a serpentine line on the surface of the substrate 110, or as a T-shaped microstrip line by branching at the end, as shown in FIG. 3e. For a feeding structure including a T-shaped microstrip line, the controlled frequency is lower than the TE101 mode. The branch lengths on both sides of the T-shaped microstrip line can be set. Since this microstrip mode does not merge with the TE101 mode, the TE101 and TE102 modes are “squeezed” together to form a broadband, as shown in FIG. 3f, where the solid line is the simulation result obtained after forming the T-shaped microstrip line and lengthening the microstrip line.

In one implementation, the feeding structure can form multiple current loops through branching of the microstrip line, and the multiple current loops are fed by a single path, making the excited mode purer.

In one implementation, the feeding structure includes a first feeding structure and/or a second feeding structure, and a feeding phase difference of 180° is provided between the first feeding structure and the second feeding structure, that is, when the first feeding structure and the second feeding structure are excited in phase, current directions in current loops of the first feeding structure and the second feeding structure are opposite.

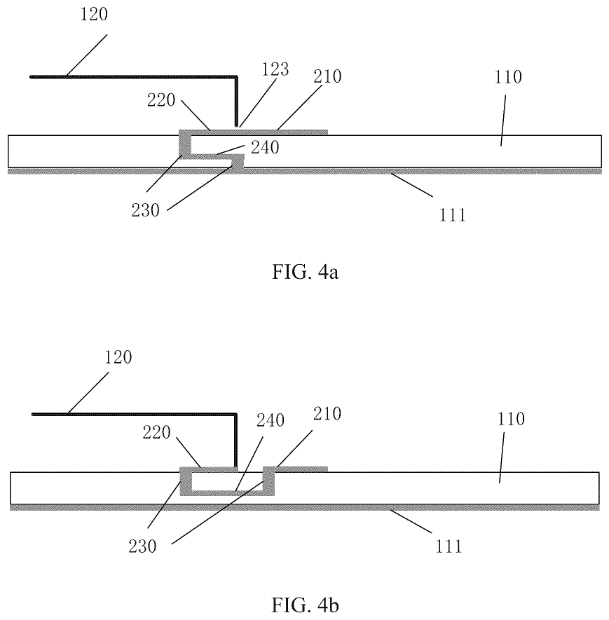

In one implementation, the first feeding structure may be as shown in FIG. 4a. In the first feeding structure, the feed line 210 is connected to one end of the microstrip line 220 through the avoidance hole 123 in the sidewall of the metal shielding cover 120, the other end of the microstrip line 220 is connected to the via metal 230, and the via metal 230 forms a bent segment through an inner-layer metal line 240 inside the substrate 110 and is connected to the metal ground plane 111, thereby forming current-loop feeding. The second feeding structure may be as shown in FIG. 4b. In the second feeding structure, the feed line 210 is connected to the via metal 230 through the interior of the substrate 110. For example, the feed line 210 is connected to the inner-layer metal line 240 inside the substrate 110 through the via metal 230 located outside the metal shielding cover 120, the inner-layer metal line 240 connects the via metal 230 located outside the metal shielding cover 120 to the via metal 230 located inside the metal shielding cover 120, the via metal 230 located inside the metal shielding cover 120 is connected to one end of the microstrip line 220, and the other end of the microstrip line 220 is connected to the sidewall of the metal shielding cover 120 close to the feed line 210, forming current-loop feeding. If the first feeding structure and the second feeding structure are excited in phase, current directions in the current loops of the first feeding structure and the second feeding structure are opposite, and the feeding phases actually differ by 180°.

In one implementation, a portion of the substrate 110 inside the metal shielding cover 120 has a protruding portion 112, where the trace of the second portion of the feeding structure located inside the metal shielding cover 120 is routed over the protruding portion 112. For example, the second portion includes the microstrip line 220 distributed on the upper surface of the protruding portion.

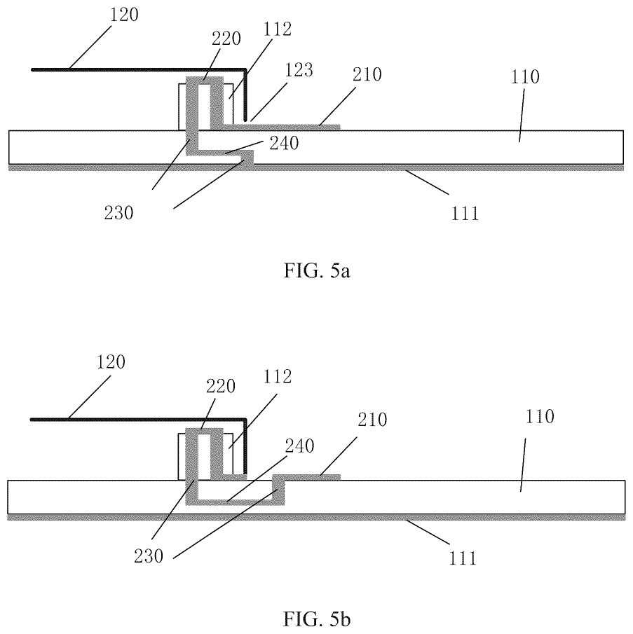

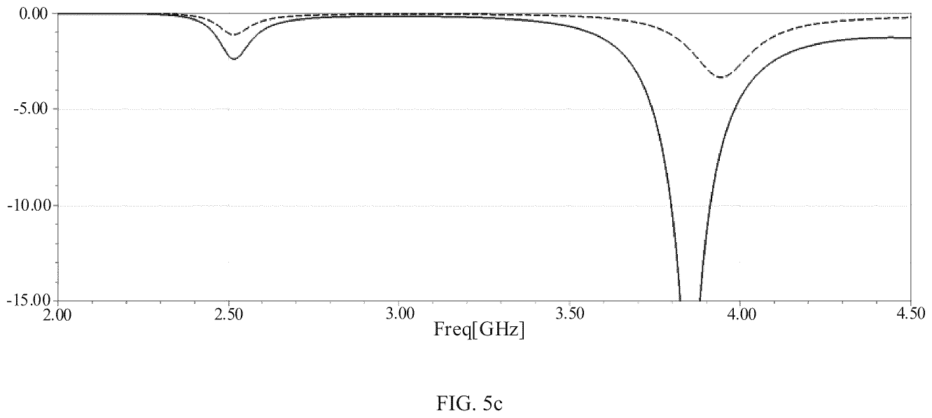

As shown in FIG. 5a, it is a schematic structural diagram of the antenna apparatus obtained by adding a protruding portion of the substrate 110 on the basis of the antenna apparatus provided in FIG. 4a. As shown in FIG. 5b, it is a schematic structural diagram of the antenna apparatus obtained by adding a protruding portion of the substrate 110 on the basis of the antenna apparatus provided in FIG. 4b. It can be seen that as compared with the feeding structures in FIG. 4a and FIG. 4b, the current loops formed by the feeding structures in FIG. 5a and FIG. 5b have a longer longitudinal height, and the microstrip line 220 is positioned closer to the top wall of the metal shielding cover 120. As shown in FIG. 5c, it is a simulation result diagram obtained by setting different distances between the microstrip line 220 and the metal shielding cover 120, where the dashed line is the standing-wave performance without the protruding portion of the substrate 110, and the solid line is the standing-wave performance of the substrate 110 with a protruding portion. It can be seen that increasing the longitudinal height of the current loop by adding the protruding portion of the substrate 110 can improve the standing-wave performance. In the practical design of the antenna apparatus, when the distance between the metal shielding cover 120 and the substrate 110 is small, that is, when the height of the metal shielding cover 120 is low, the feeding structures similar to those in FIG. 4a and FIG. 4b may be adopted. When the distance between the metal shielding cover 120 and the substrate 110 is large, that is, when the height of the metal shielding cover 120 is high, the feeding structures similar to those in FIG. 5a and FIG. 5b may be adopted to improve the standing-wave performance.

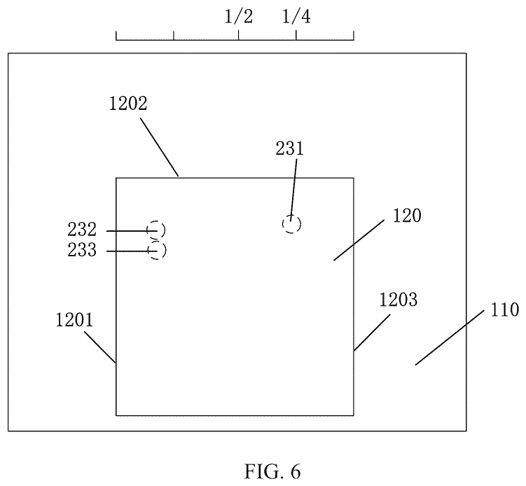

In one implementation, the antenna apparatus includes three feeding structures located at a first position 231, a second position 232 and a third position 233, respectively. As shown in FIG. 6, the sidewalls of the metal shielding cover 120 sequentially include a first sidewall 1201, a second sidewall 1202 and a third sidewall 1203, where the length of the second sidewall 1202 is a, and lengths of the first sidewall 1201 and the third sidewall 1203 are d. The via metal of the feeding structure located at the first position is spaced from the third sidewall by a/4, and the via metals of the feeding structure located at the second position and the feeding structure located at the third position are spaced from the second sidewall by d/4.

The feeding structure located at the first position adopts a vertical feeding structure. It can be understood that the feeding structure located at the first position passes through the second sidewall 1202. The feeding structures located at the second position and the third position adopt horizontal feeding structures. It can be understood that the feeding structures located at the second position and the third position pass through the second sidewall 1202 or the third sidewall 1203. The feeding structure located at the first position is in phase with the feeding structure located at the second position, and the feeding structure located at the first position is in opposite phase with the feeding structure located at the third position.

In one implementation, the feeding structures located at the first position and the second position may adopt the first feeding structure, and the feeding structure located at the third position may adopt the second feeding structure. In this way, when these feeding structures are excited in phase, the feeding structure located at the first position is in phase with the feeding phase of the feeding structure located at the second position, and the feeding structure located at the first position is in opposite phase with the feeding structure located at the third position. For example, the feeding structures located at the first position and the second position may adopt the first feeding structure as shown in FIG. 4a, and the feeding structure located at the third position may adopt the second feeding structure as shown in FIG. 4b.

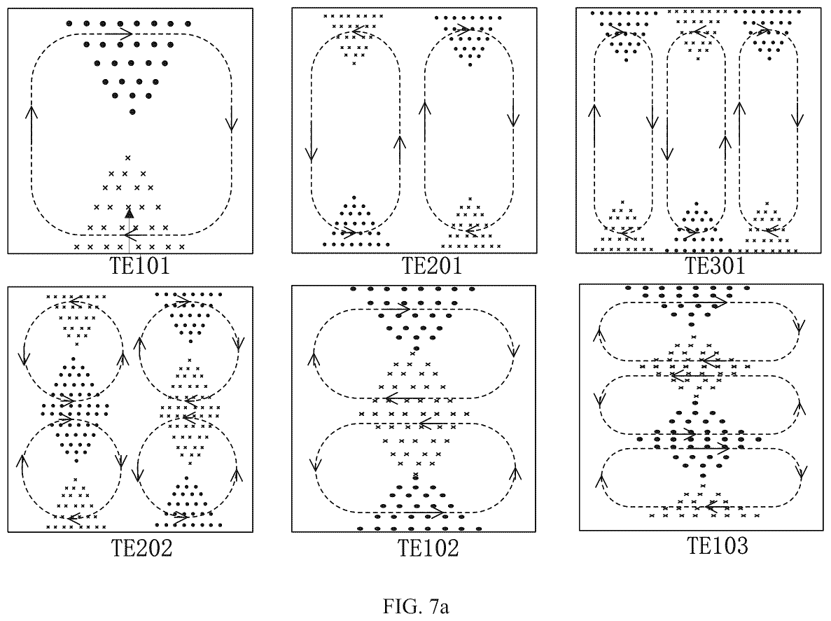

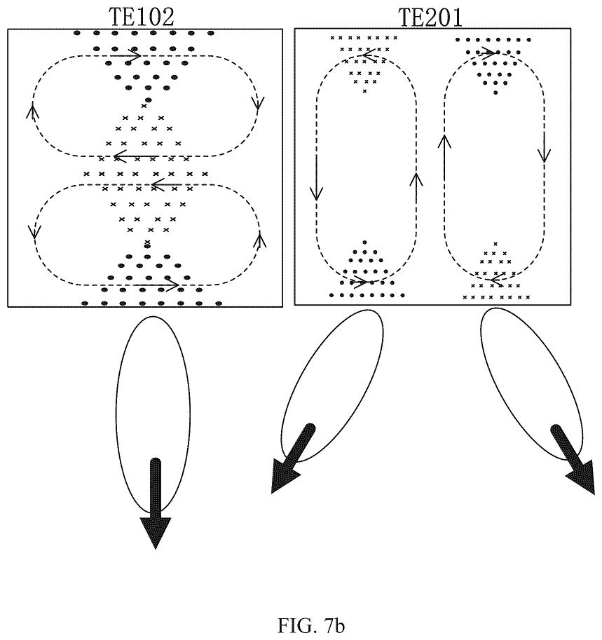

The antenna apparatus provided in this embodiment includes a first operating state and a second operating state, where the first operating state is that the feeding structure located at the first position and the feeding structure located at the second position are excited with equal amplitude and in phase, and the second operating state is that the feeding structure located at the first position and the feeding structure located at the third position are excited with equal amplitude and in phase. When the feeding structure at the first position and the feeding structure at the second position are excited with equal amplitude and in phase, modes such as TE201 and TE301 are excited. When the feeding structure at the first position and the feeding structure at the third position are excited with equal amplitude and in phase, modes such as TE101, TE102, TE103, and TE202 are excited. The electric and magnetic field distributions of TE101, TE102, TE103, TE201, TE202, and TE301 modes are shown in FIG. 7a.

For the first operating state and the second operating state, there are two pairs of modes with the same frequency: TE102 and TE201, TE103 and TE301. Taking TE102 and TE201 as an example, the electromagnetic fields of TE102 and TE201 are orthogonal, as shown in FIG. 7b, where arrows indicate the maximum radiation direction. The maximum radiation direction of TE102 is the same as the opening direction of the metal shielding cover 120, and the maximum radiation direction of TE201 is blocked by the sidewall of the metal shielding cover 120, forming a two-ended radiation pattern, which is nearly complementary to the maximum radiation direction of TE102. Therefore, by setting feeding structures and feeding different feeding structures to form different current-loop feeding respectively, multi-mode excitation can be achieved, and the radiation pattern can be changed by switching the excited current loop pair.

In one implementation, the antenna apparatus provided in the above embodiment is disposed in an electronic device, and a metal back cover of the electronic device may be used as the metal ground plane 111 in the antenna apparatus.

An embodiment of the present application further provides an electronic device including any of the above antenna apparatuses. To avoid repetition, details are not described herein again. The electronic device may include an all-metal shell, and the above antenna apparatus may use the metal shell of the electronic device as the metal ground plane 111.

It should be noted that, in this document, the terms “comprise,” “include,” or any other variants thereof are intended to cover non-exclusive inclusion, so that a process, method, article, or apparatus that includes a series of elements not only includes those elements, but also includes other elements that are not explicitly listed, or also includes elements inherent to such process, method, article, or apparatus. In the absence of more restrictions, an element defined by the statement “including one . . . ” does not exclude the existence of another identical element in the process, method, article, or apparatus that includes the element.

The embodiments of the present application have been described above in conjunction with the drawings, but the present application is not limited to the above implementations. The above implementations are merely illustrative and not restrictive. Under the enlightenment of the present application, those of ordinary skill in the art can make many forms without departing from the purpose of the present application and the scope of protection of the claims, all of which fall within the protection of the present application.

1. An antenna apparatus, comprising: a substrate; a metal shielding cover disposed on the upper surface of the substrate; a metal ground plane disposed on the lower surface of the substrate; and at least one feeding structure,
wherein:
the metal shielding cover has an open side, wherein: the open side faces an edge of the substrate, and a sidewall of the metal shielding cover is connected to the metal ground plane; and
the feeding structure comprises: a first portion located outside the metal shielding cover, and a second portion located inside the metal shielding cover, wherein the first portion and the second portion being connected to each other through the sidewall of the metal shielding cover, wherein the feeding structure is configured to form a current loop inside a cavity of the metal shielding cover to excite a cavity antenna.

2. The antenna apparatus according to claim 1,
wherein:
the first portion comprises a feed line located on the upper surface of the substrate, and
the second portion comprises: a microstrip line located on the upper surface of the substrate, and a via metal located inside the substrate.

3. The antenna apparatus according to claim 2,
wherein:
the feeding structure comprises a vertical feeding structure or a horizontal feeding structure,
a feeding direction of the vertical feeding structure coincides with an opening direction of the metal shielding cover, and
a feeding direction of the horizontal feeding structure is orthogonal to the opening direction of the metal shielding cover.

4. The antenna apparatus according to claim 3,
wherein:
the feeding structure comprises a first feeding structure,
in the first feeding structure, the feed line is connected to one end of the microstrip line through an avoidance hole in the sidewall of the metal shielding cover,
the other end of the microstrip line is connected to the via metal, and
the via metal is connected to the metal ground plane.

5. The antenna apparatus according to claim 3,
wherein:
the feeding structure comprises a second feeding structure,
in the second feeding structure, the feed line is connected to the via metal through the interior of the substrate,
the via metal is connected to one end of the microstrip line, and
the other end of the microstrip line is connected to the sidewall of the metal shielding cover close to the feed line.

6. The antenna apparatus according to claim 5,
wherein:
the feeding structure comprises the first feeding structure and the second feeding structure, and
a feeding phase difference of 180° is provided between the first feeding structure and the second feeding structure.

7. The antenna apparatus according to claim 6,
wherein:
the at least one feeding structure comprises three feeding structures located at a first position, a second position and a third position, respectively;
the sidewall of the metal shielding cover sequentially comprises a first sidewall, a second sidewall and a third sidewall; and
a length of the second sidewall is a, and lengths of the first sidewall and the third sidewall are d, wherein: the via metal of the feeding structure located at the first position is spaced from the third sidewall by a/4, and the via metals of the feeding structure located at the second position and the feeding structure located at the third position are spaced from the second sidewall by d/4; and
the feeding structure located at the first position adopts a vertical feeding structure, the feeding structures located at the second position and the third position each adopt a horizontal feeding structure, the feeding structure located at the first position is in phase with the feeding structure located at the second position, and the feeding structure located at the first position is in opposite phase with the feeding structure located at the third position.

8. The antenna apparatus according to claim 7, wherein the antenna apparatus comprises a first operating state and a second operating state,
wherein:
the first operating state is that the feeding structure located at the first position and the feeding structure located at the second position are excited with equal amplitude and in phase, and
the second operating state is that the feeding structure located at the first position and the feeding structure located at the third position are excited with equal amplitude and in phase.

9. The antenna apparatus according to claim 1, wherein the substrate inside the metal shielding cover has a protruding portion, wherein the trace of the second portion is routed over the protruding portion.

10. The antenna apparatus according to claim 1,
wherein:
the antenna apparatus is disposed in an electronic device, and
the metal ground plane is a metal back cover of the electronic device.

11. The antenna apparatus according to claim 4,
wherein:
the feeding structure comprises a second feeding structure,
in the second feeding structure, the feed line is connected to the via metal through the interior of the substrate,
the via metal is connected to one end of the microstrip line, and
the other end of the microstrip line is connected to the sidewall of the metal shielding cover close to the feed line.

12. The antenna apparatus according to claim 11,
wherein:
the feeding structure comprises the first feeding structure and the second feeding structure, and
a feeding phase difference of 180° is provided between the first feeding structure and the second feeding structure.

13. The antenna apparatus according to claim 12,
wherein:
the at least one feeding structure comprises three feeding structures located at a first position, a second position and a third position, respectively;
the sidewall of the metal shielding cover sequentially comprises a first sidewall, a second sidewall and a third sidewall; and
a length of the second sidewall is a, and lengths of the first sidewall and the third sidewall are d, wherein: the via metal of the feeding structure located at the first position is spaced from the third sidewall by a/4, and the via metals of the feeding structure located at the second position and the feeding structure located at the third position are spaced from the second sidewall by d/4; and
the feeding structure located at the first position adopts a vertical feeding structure, the feeding structures located at the second position and the third position each adopt a horizontal feeding structure, the feeding structure located at the first position is in phase with the feeding structure located at the second position, and the feeding structure located at the first position is in opposite phase with the feeding structure located at the third position.

14. The antenna apparatus according to claim 13, wherein the antenna apparatus comprises a first operating state and a second operating state,
wherein:
the first operating state is that the feeding structure located at the first position and the feeding structure located at the second position are excited with equal amplitude and in phase, and
the second operating state is that the feeding structure located at the first position and the feeding structure located at the third position are excited with equal amplitude and in phase.
